(19) United States
(12) Patent Application Publication
(10) Pub. No.: US 2007/0114327 A1
(43) Pub. Date: May 24, 2007

(54) Wing load alleviation apparatus and method

(75) Inventors: Paul W. Dees, Woodinville, WA (US); Mithra Sankrithi, Lake Forest Park, WA (US)

Correspondence Address: HARNESS DICKEY & PIERCE, PLC, P.O. BOX 828, BLOOMFIELD HILLS, MI, 48303, US

(73) Assignee: The Boeing Company

(21) Appl. No.: 11/283,586

(22) Filed: Nov. 18, 2005

(51) Int. Cl. B64C 39/06

(52) U.S. Cl. 244/34 R

(57) ABSTRACT

A wing load alleviation system and method for alleviating the lift-inducing structural-bending force (i.e., moment) experienced by each of the wings of an aircraft. The apparatus includes a deployable panel and an actuator mounted in each wing. The actuators are responsive to a command generator. The actuator is mounted inside the wing and the panel is mounted flush with an outer surface of its respective wing. Each panel can be moved between a retracted position, where it has no affect on airflow moving over the wing, to a deployed position in which it deflects air off of the wing. Each panel is preferably located at a span-wise location at least about halfway along the length of the wing toward the wing tip, and more preferably at least in part outboardly of the outboard-most trailing edge device in the wing. The apparatus effectively shifts the lift-inducing structural-bending forces experienced by the wing more inboard towards the fuselage.

### FIELD OF THE INVENTION

The present invention relates to aircraft, and more particularly to a system adapted to alleviate lift-induced structural-bending loads experienced by the wings of an aircraft during flight.

### BACKGROUND OF THE INVENTION

The wing structure of a typical, modern day jet aircraft is designed at least in part by considering critical loads at limiting flight or ground conditions. Typically, a limiting flight condition is one at which high load factors are experienced, and is one that is usually avoided during normal flight operations. The wing structure has to be designed with sufficient strength to thus be able to accommodate the high load factors that are experienced at a limiting flight condition, even though such a condition will rarely, or possibly never, be encountered during flight of the aircraft.

Designing wing structure to accommodate the high load factors that are experienced at limiting flight conditions requires that the wing spars and other structural components within the wing be made sufficiently robust to withstand the high load factors. However, this results in a wing that is heavier than would otherwise be required to accommodate normal load factors that are typically experienced during flight.

The overall structural weight of the wing and/or attachment structure for attaching the wings to the fuselage could be reduced if at key critical load conditions the spanwise location of the lift experienced by each wing was to be moved more inboard and/or reduced in magnitude during flight. Reducing the overall weight of the wings would result in a lighter aircraft that is able to fly further with a given payload. Alternatively, moving the spanwise aerodynamic load distribution more inboard along the wings, would allow the aircraft to accommodate even more revenue-generating payload, thus enhancing the value of the aircraft. Being able to move the lift-inducing structural-bending forces experienced by the wings more inboard towards the fuselage of the aircraft would also allow the wing span of the wings to be increased while retaining much of the original wing frame and attachment structure (i.e., with less structural weight for the extended length wings).

### SUMMARY OF THE INVENTION

The present invention is directed to an apparatus and method for alleviating the lift-inducing forces experienced near the outer tips of the wings of an aircraft, and moving the lift-inducing structural bending forces more inboard, spanwise, along the wings towards the fuselage of the aircraft.

In one preferred embodiment, deployable panels are located in an upper surface of each wing at a spanwise location that is at least about halfway out to the tip of the wing. When the panels are deployed into the airstream, this reduces the local aerodynamic loads experienced at the outer tips of the wings and effectively moves the bending forces more inboard (i.e., spanwise) along the wings towards the fuselage. The panels, in one preferred form, are deployed by actuators mounted within each wing. The actuators are in turn controlled by a flight control system on the aircraft.

By reducing the aerodynamic load distribution experienced at the outboard half of the wings, and effectively moving this force more inboard along the wings closer to the fuselage, the maximum payload able to be carried by the aircraft can be increased. The aerodynamic load induced bending moment on the wing is defined as follows:

$$M ( {γ}^{0} ) = {\int }_{{γ}^{0}}^{b / 2} \frac{1}{2} ρ {v}^{2} {C}_{L} ( γ ) ( γ - {γ}^{0} ) c ( γ ) ⅆ γ$$

where: γ is a spanwise distance coordinate; γ⁰ is a particular spanwise location; M(γ⁰) is the aerodynamic load induced bending moment on the wing at spanwise coordinate γ⁰; C_{L}(γ) is lift coefficient at spanwise coordinate γ; ρ is air density; ν is airspeed; c(γ) is wing chord at spanwise coordinate γ; and b/2 is the semispan of the aircraft.
   Alternatively, the internal structure of the wings (e.g., wing spars) can be made lighter in weight because of the reduced aerodynamic loads and induced bending moments that need to be accommodated by the wings. Alternatively, longer wings could be employed without requiring significantly heavier structure.

Further areas of applicability of the present invention will become apparent from the detailed description provided hereinafter. It should be understood that the detailed description and specific examples, while indicating various preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1A, 1B and 1C are plan views of aircraft incorporating preferred embodiments of the wing load alleviation device in each wing;

FIG. 2 is an enlarged perspective view of an outermost portion of one of the wings of the aircraft in FIG. 1A showing a panel of the wing load alleviation device in solid lines in its retracted position;

FIG. 3 is a simplified side cross sectional view of the wing of the aircraft in FIG. 1A taken in accordance with section line 3-3 in FIG. 1A illustrating the panel in the retracted position;

FIG. 4 is a view of the wing of FIG. 3, but showing the panel in the deployed (i.e. extended) position; and

FIG. 5 is a graph illustrating the load experienced by one of the wings over its spanwise length with the panel deployed, and also with the panel in its retracted position.

### DETAILED DESCRIPTION OF THE PREFERRED EMBODIMENTS

The following description of the preferred embodiment(s) is merely exemplary in nature and is in no way intended to limit the invention, its application, or uses.

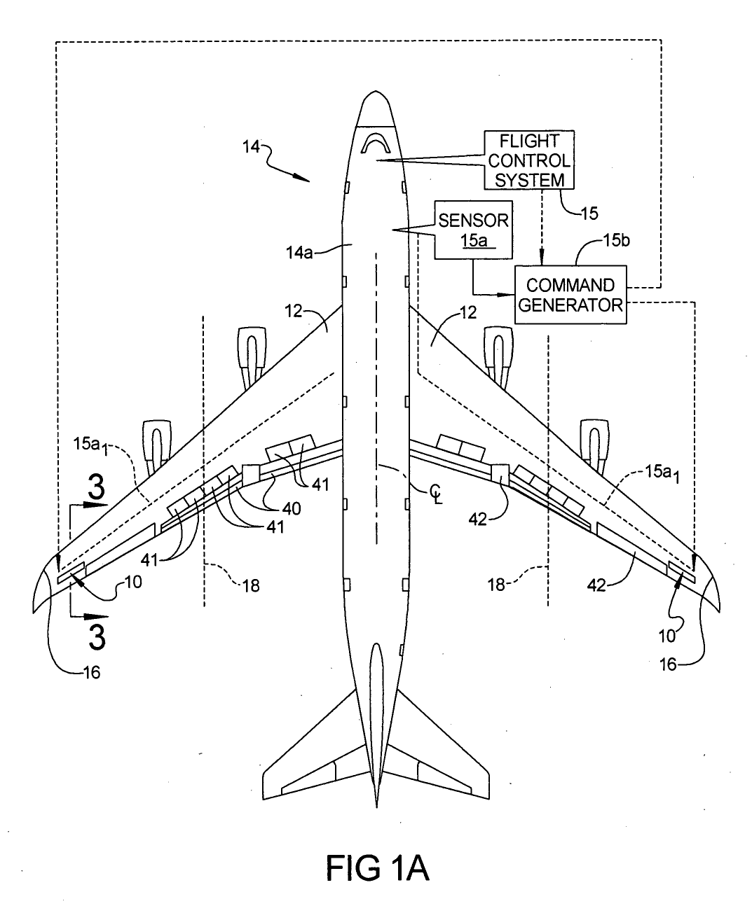

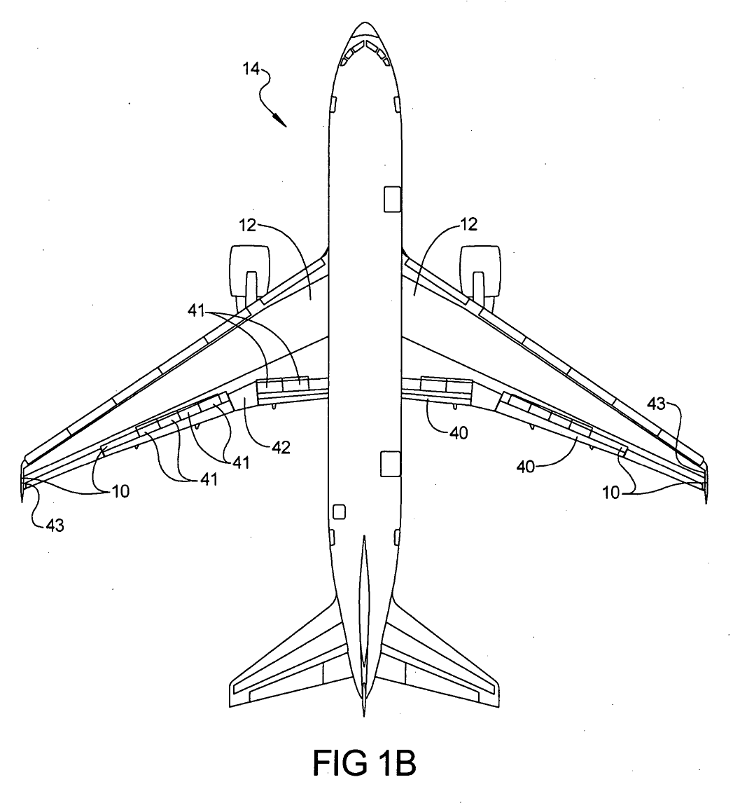

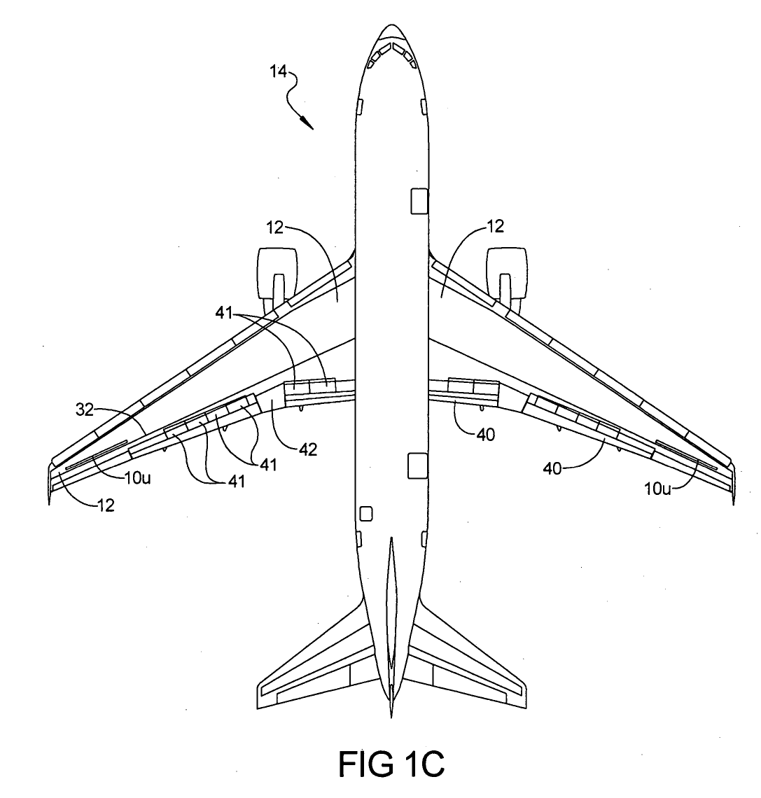

Referring to FIG. 1A, a wing load alleviation apparatus 10 in accordance with a preferred embodiment of the present invention is illustrated located in each wing 12 of an aircraft 14. In this example the aircraft is a modern day, commercial jet aircraft having a flight control system 15, although it will be appreciated that the apparatus 10 could be employed in propeller or turboprop driven aircraft as well. The aircraft may be a subsonic transport equipped with a swept, moderate or high aspect ratio wing and turbofan engines. The wing could employ metallic structure such as structure using aluminum alloy material, or composite structure such as structure using carbon-epoxy or other composite material, or a hybrid of metallic and composite structure. The apparatus 10 may be located at any outboard spanwise point along the length of its associated wing 12, although preferably it is located at a spanwise position near to the tip 16 of its associated wing 12 and, more preferably, at least about halfway out of the tip 16. Even more preferably, the apparatus 10 is positioned outboardly, of an outboard-most trailing edge device, as will be explained more fully in the following paragraphs.

The apparatus 10 is in communication with a command generator 15B for generating commands to control the apparatus. A sensor system 15A is used to sense the presence of lift-inducing structural-bending forces and moments being experienced by the wings. The sensor system 15A may comprise one or more of an inertial load factor sensor, a pitch rate sensor or even strain gauge sensors 15A, positioned in each wing 12. The command generator 15B may comprise a microprocessor, a digital computer, an analog computer, or any other form of system capable of generating the required command signals to the apparatus 10. The command generator 15B is able to apply commands to each apparatus 10 in each wing 12 independently if needed. Commands may be based on information from the sensor system 15A, the flight control system 15, or a combination of both, as well as from pilot input(s). The apparatus 10 could also be controlled in conjunction with other deployable components on the wing 12, such as ailerons, flaperons, elevons, flaps, etc.

In the embodiment of FIG. 1A, the air deflecting members forming the apparatus 10 are located outboard of the outboard-most of the ailerons 42, as well as outboard of the trailing edge flaps 40 and the typical spoilers or speed brake panels 41.

FIG. 1B illustrates a variant preferred embodiment in which the outboard-most trailing edge devices comprise the outboard-most pair of flaps 40, and where a pair of air deflecting panels forming the apparatus 10 are located at least in part outboard and forward of the outboard-most pair of flaps 40. The embodiment of FIG. 1B also shows the apparatus 10 as including another pair of air deflecting panels located on the inner surfaces of upwardly-oriented winglet members 43 at the outer ends of the wings 12.

FIG. 1C illustrates another preferred embodiment in which upper edges of air deflecting panels 10U are adjacent to the upper surface of the wings 12, at least in part outboard of the outboard-most pair of flaps 40 and, in this case, forward of a rear spar 32. In this embodiment, the air deflecting panels of the apparatus 10 can be controllably extended by at least one activator (inside the wing 12 and so not shown) translating the upper edge upward into the airstream above the wing 12. FIG. 1C shows panels 10U forward of the rear spar 32; however, an alternate embodiment would place them aft of the rear spar 32.

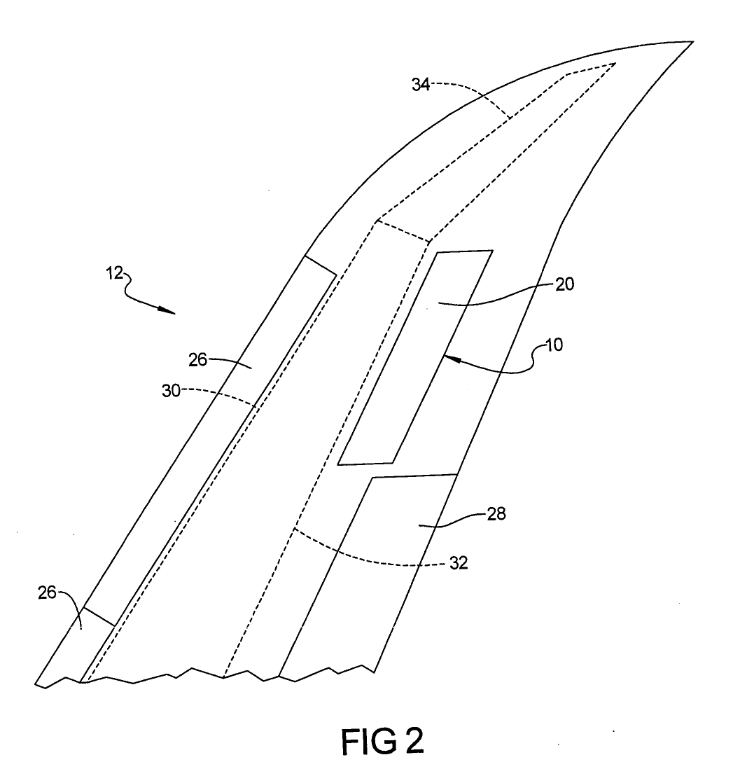

With reference to FIGS. 2-4, the apparatus 10 includes a panel 20 that is movable by an actuator 22 mounted within the wing 12. The panel 20 could be a flap or spoiler. The panel 20 includes a leading edge 20b and a trailing edge 20c. The panel is coupled to the wing 12 for pivotal movement about or near its leading edge 20b. The actuator may be an electrical, hydraulic, electrohydraulic or pneumatic actuator, or any other suitable form of actuator that is able to move the panel 20 into an airstream 24 flowing over the wing 12. Many forms of actuators that are suitable for use in aircraft and aerospace applications could be employed. The actuator 22 is coupled with the flight control system 15.

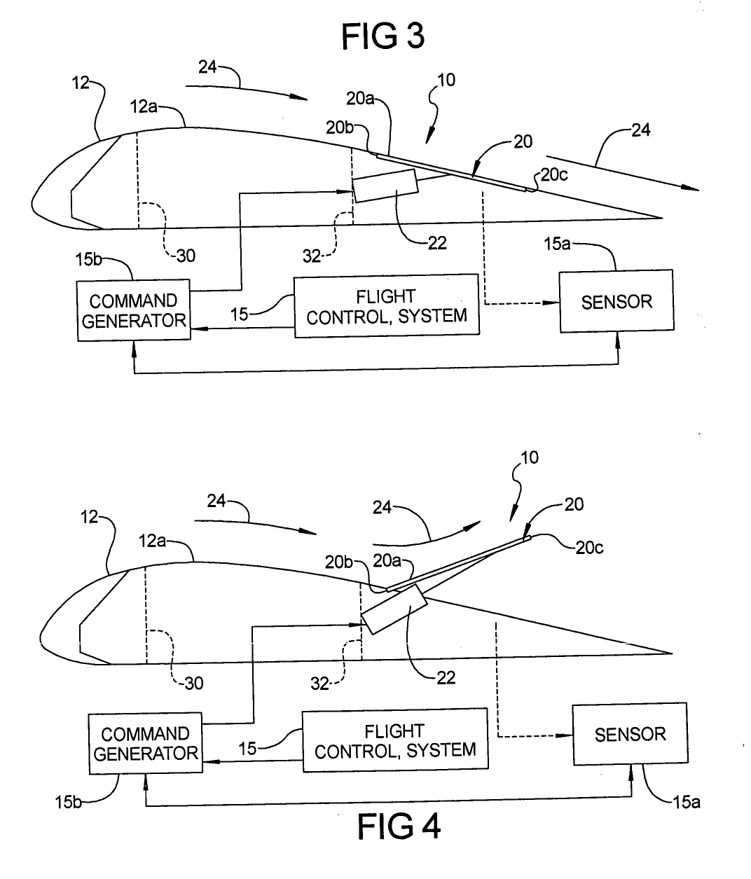

With specific reference to FIG. 2, the wing 12 is otherwise of conventional construction and typically includes one or more leading edge slats 26 and one or more ailerons 28. A front spar 30 and a rear spar 32 are indicated in dash lines, as is a wing tip spar box 34. Thus, the inclusion of the wing load alleviation device 10 does not otherwise require significant alternation of the traditional construction and internal components of the wing 12. From FIGS. 2 and 3, it can be seen that the panel 20 includes an outer surface 20a that has a contour generally in accordance with a contour of an upper surface 12a of the wing 12. Thus, when the panel 20 is in its retracted position as shown in FIG. 3, the panel has no tangible affect on the airflow 24 over the wing 12. The panel 20 may be made of aluminum, from composites, or from other suitably strong, lightweight and durable materials. The panel 20 is also preferably located outboardly, spanwise, of the aileron 28, which in this example is the outboard-most trailing edge device on the wing 12. It will be appreciated that the outboard-most trailing edge device could also be a flap, a flaperon or an elevon. The panel 20 is also preferably located rearwardly of the rear spar 32 and elevationally above the midplane of the wing box formed by the spars 30 and 32 and upper and lower wing skins.

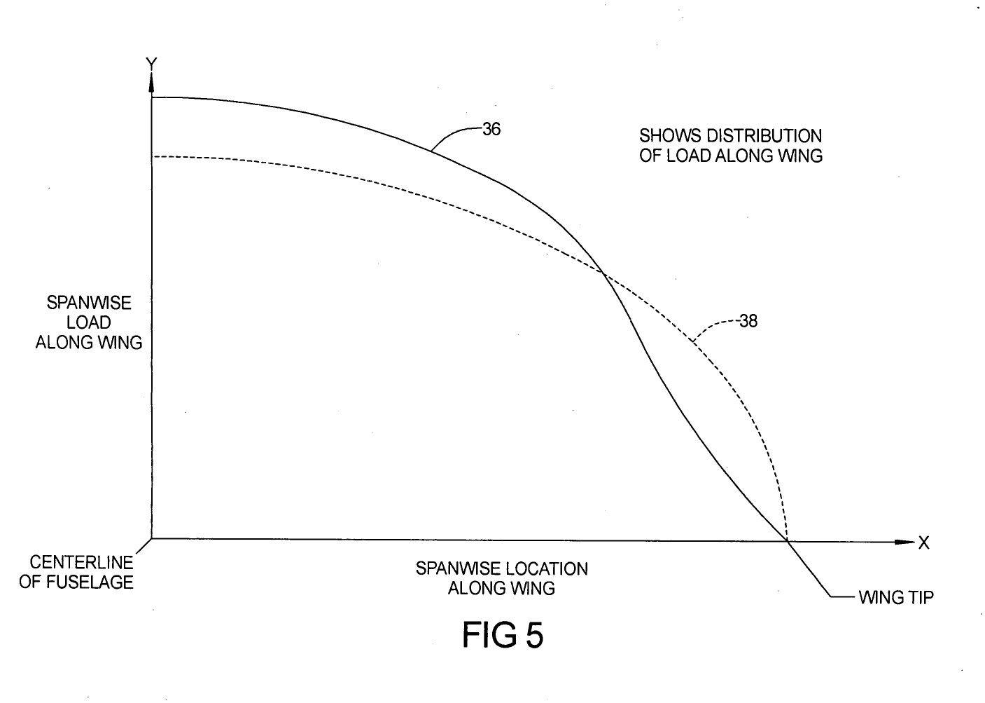

With continued reference to FIGS. 3 and 4, when the actuator 22 receives a signal from the command generator 15B to deploy the panel 20, the actuator extends the panel 20 from the stowed position shown in FIG. 3 into the deployed position shown in FIG. 4. This has the effect of reducing local aerodynamic lift forces near the panel 20, and thus reducing the aerodynamic lift induced load distribution experienced along the wing inboard to the side of body. The aerodynamic lift-induced load distribution is effectively shifted spanwise along the wing 12 towards the centerline (C_{L} in FIG. 1) of the fuselage 14a of the aircraft 14. Moving the lift-inducing structural-bending forces and moments more inboard spanwise along the wings 12 has the effect on wing loads of equivalently decreasing the wing span.

By effectively shifting the aerodynamic load distribution more inboard, spanwise, along the wings 12, the apparatus 10 allows an even greater payload to be carried by the aircraft 12 than what would otherwise be possible without the use of the apparatus 10. Alternatively, the structural framework of the wings 12 could be made lighter in weight because the maximum aerodynamic loads that each wing needs to be able to accommodate would be less when the apparatus 10 is employed in each wing 12. Still further, the use of the apparatus 10 in each wing 12 could alternatively allow a wing of even longer span to be used with a given wing structural design.

Referring to FIG. 5, a conceptual graph of the spanwise load experienced by the wing at various spanwise locations along the wing is illustrated when the apparatus 10 is deployed and also when it is retracted. Curve 36 represents the spanwise load with the apparatus 10 in its deployed position, while curve 38 represents the spanwise load with the apparatus 10 in its retracted position. Curve 36 illustrates that a greater portion of the load is shifted toward the center line (C_{L}) of the fuselage 14a of the aircraft 14 with the apparatus 10 in its deployed position. Curve 36 also indicates that the spanwise load experienced near the wing tip 16 is significantly reduced with the apparatus 10 deployed. A wing load alleviation control law (i.e. algorithm) will typically command deployment of the panel 20 when the aircraft is experiencing a current or anticipated maneuver or gust load factor above a threshold value, which may be at least or near a limit load factor (2.5 g's), or more generally anywhere between 1.25 g's and 3.75 g's. The current load factor can be obtained from an inertial load sensor sensing load factor N_{z}, and the anticipated load factor can be synthesized from a combination of N_{z} and at least one of \dot{N}_{z} and pitch acceleration \dot{q}. Individual left and right wing load factor connections may be completed as a function of roll acceleration \dot{p}, in one preferred embodiment.

The apparatus 10 can be employed on virtually any form of airborne mobile platform that makes use of wings. The apparatus can be used in connection with wings having a winglet, a wing tip extension, or both, or a raked tip. In such instances, the panel 20 could be located inboardly of the winglet, wing tip extension or raked tip, or possibly within a portion of the wing tip extension or raked tip. In such instances, the downward incremental life generated by the panel 20 may be enhanced by the presence of the winglet, wing tip extension or raked tip. The command generator 15B can be used in connection with a suitable algorithm to apply suitable control signals to each apparatus 10 independently of the other and also in response to the detection of a maneuver limit load condition being exceeded, or about to be exceeded, or the detection of the actual or incipient detection of the exceedance of gust limit load conditions.

Furthermore, the apparatus 10 can be employed on wings that are formed with aluminum, composite materials, etc., and therefore is not limited to any specific material construction that is employed on the wings.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. An aircraft comprising:
a fuselage;
a pair of wings extending from the fuselage;
each of said wings including:
an outboard-most, trailing edge flight control device for assisting in controlling flight of said aircraft;
a load alleviation system positioned in the wing at a spanwise position at least about halfway between an inboard end of the wing and a tip of the wing, and at a point between a leading edge and a trailing edge of the wing, and further being positioned adjacent an upper surface of the wing and at least in part outboardly, spanwise, of said outboard-most trailing edge flight control device of the wing;
the load alleviation system including an air deflecting member that can be controllably extended independent of its associated said outboard-most, trailing edge flight control device, and that is located remote from its associated said outboard-most, trailing edge flight control device, to project outwardly from the upper surface of the wing to alleviate a lift-induced structural-bending load experienced by the wing at said inboard end during flight; and
a command generator in communication with the load alleviation system for applying signals to the load alleviation system to deploy and retract the air deflecting member as needed to alleviate said lift-induced structural-bending loads.

2. (canceled)

3. The aircraft of claim 1, further comprising a sensor in communication with the load alleviation system for sensing a present or future developing load condition requiring use of said load alleviation system.

4. The aircraft of claim 1, wherein the load alleviation system includes an actuator disposed within said wing for moving said air deflecting member between a retracted position and an extended position.

5. The aircraft of claim 1, wherein the air deflecting member comprises a pivotally supported panel.

6. The aircraft of claim 1, wherein the air deflecting member can be moved into a retracted position in which an upper surface of the air deflecting member is flush with said upper surface of said wing.

7. The aircraft of claim 1, wherein an upper surface of said air deflecting member is adjacent said upper surface of the wing when said air deflecting member is undeployed, and wherein said air deflecting member can be controllably extended by at least one actuator rotating said air deflecting member about a hingeline forwardly disposed relative to said air deflecting member.

8. The aircraft of claim 1, wherein an upper edge of said air deflecting member is adjacent said upper surface of the wing when said air deflecting member is undeployed, and wherein said air deflecting member can be controllably extended by at least one actuator translating said upper edge upward into the airstream above said wing.

9. The aircraft of claim 1, further comprising a flight control system for assisting in controlling operation of said load alleviation system.

10. The aircraft of claim 1, wherein the load alleviation system in each said wing is controllable independently of the other.

11. A wing load alleviation system for use with an airborne mobile platform having at least one wing, with the wing having an outboard-most, trailing edge, flight control device for assisting in controlling flight of the airborne mobile platform, the system comprising:
an air deflecting member positioned in the wing between an inboard end of the wing and a tip of the wing and outwardly of the outboard-most, trailing edge flight control device of the wing, and also at a chordwise point between a leading edge and a trailing edge of the wing, and adjacent an upper surface of the wing, the air deflecting member being located remotely from the outboard-most, trailing edge flight control device and able to operate independently of the outboard-most, trailing edge flight control device;
an actuator for moving the air deflecting member between a retracted position, in which the air deflecting member is generally flush with said upper surface of the wing, and a deployed position in which the air deflecting member extends outwardly from the upper surface of the wing into an air stream flowing over the upper surface of the wing; and
the air deflecting member operating, when in said deployed position, to alleviate a lift-induced structural-bending load experienced by the wing.

12. The system of claim 11, further comprising a command generator for generating commands to control said actuator.

13. The system of claim 11, further comprising a sensor for sensing present or future developing load conditions requiring use of said air deflecting member.

14. The system of claim 11, wherein said air deflecting member is positioned in said wing at least about halfway between said inboard end and said tip of said wing.

15. The system of claim 11, wherein said air deflecting member is positioned at a point in said wing more than half a distance from said inboard end to said tip of said wing.

16. The system of claim 11, wherein the air deflecting member comprises a panel.

17. The system of claim 11, wherein the air deflecting member includes a leading edge and a trailing edge, and wherein the air deflecting member is supported for pivotal movement about said leading edge.

18. The system of claim 11, wherein the air deflecting member has an upper surface that is contoured in accordance with said upper surface of said wing.

19. The system of claim 11, wherein said tip of the wing comprises an upper tip of an upwardly-oriented winglet member at an outer end of the wing, wherein said upper surface of the wing includes a contiguous inner surface of said upwardly-oriented winglet member, and wherein said air deflecting member is generally flush with said inner surface of said upwardly-oriented winglet member when in said retracted position.

20. A method for alleviating a lift-induced structural-bending force experienced by a wing of an airborne mobile platform during flight of the mobile platform, wherein the wing includes an outboard-most, trailing edge flight control device for assisting in controlling flight of the airborne mobile platform, the method comprising:
positioning an air deflecting member in an upper surface of said wing of the mobile platform, at a spanwise point at least about half a distance from an inboard end of said wing to a tip of said wing and outboardly, spanwise, of said outboard-most, trailing edge flight control device, and such that said air deflecting member is positioned remotely from, and able to operable independently of, said outboard-most, trailing edge flight control device;
sensing when said wing is experiencing, or about to experience, a lift-induced structural-bending moment exceeding a predetermined threshold; and
deploying said air deflecting member, independently of said outboard-most, trailing edge flight control device, if needed, to extend into an air stream flowing over said wing, the air deflecting member operating to alleviate said lift-induced structural-bending moment experienced by said wing during flight.

21. The method of claim 20, further comprising controlling movement of said air deflecting member between a retracted position, in which said air deflecting member is positioned with an upper surface generally flush with said upper surface of said wing, and a deployed position in which said air deflecting member is extended into said air stream.

22. The method of claim 20, further comprising sensing said lift-inducing structural-bending force independently in each one of a pair of wings of said airborne mobile platform.

23. The method of claim 20, further comprising using an air deflecting member in each of a pair of wings of said airborne mobile platform, and controlling operation of each said air deflecting member independently of the other.
